(19) United States
(12) Patent Application Publication
(10) Pub. No.: US 2025/0103863 A1
(43) Pub. Date: Mar. 27, 2025

(54) NEURAL NETWORK SYSTEM WITH MULTIPLE INPUTS AND MULTIPLE OUTPUTS

(71) Applicant: International Business Machines Corporation, Armonk, NY (US)

(72) Inventors: Nicolas Andrin MENET, Zurich (CH); Michael Andreas HERSCHE, Zurich (CH); Kumudu Geethan KARUNARATNE, Zurich (CH); Abbas RAHIMI, Zurich (CH)

(21) Appl. No.: 18/471,661

(22) Filed: Sep. 21, 2023

Related U.S. Application Data
(63) Continuation-in-part of application No. 18/260,542, filed on Jul. 6, 2023, now Pat. No. 11,964,280.

(51) Int. Cl. G06N 3/0464; G06N 3/048

(52) U.S. Cl. CPC G06N 3/0464; G06N 3/048

(57) ABSTRACT

Method and apparatus for deep learning. A first input and a second input are accessed. A first embedding for the first input is generated using a binding network. A second embedding for the second input is generated using the binding network. The first and second embeddings are aggregated to generate a combined embedding. A transformation function is applied to the combined embedding to generate a transformed combined embedding. The transformed combined embedding is processed, using an unbinding network, to extract a first transformed embedding for the first input and a second transformed embedding for the second input. An inference function is applied to the first transformed embedding to generate a first output. The inference function is applied to the second transformed embedding to generate a second output.

### BACKGROUND

The present disclosure relates to deep learning, and more specifically, to a neural network system that processes multiple inputs concurrently, integrating them into a combined representation and generating multiple outputs.

With the advent of deep learning, progressively large neural network models have been developed to handle complicated tasks. However, the increased size of these models has led to a corresponding rise in the computational cost of inference.

The increased computational costs may cause a wide variety of problems. For example, the high computational demands may place a heavy burden on the existing hardware infrastructure, thereby affecting the overall stability of the system. The strain placed on the existing hardware may cause overheating issues, leading to unexpected crashes or errors in system operation and data processing. When the strain continues to escalate, the hardware may shut down entirely to prevent permanent damage. Additionally, the complex computations increase energy consumption, raising specific environmental concerns, such as increased carbon dioxide emissions. Furthermore, the significant expenses associated with the necessary hardware and energy consumption pose challenges for organizations or systems with limited computational resources, which therefore impedes the widespread application of state-of-the-art deep learning technologies.

As a result, there is a growing demand for mechanisms that minimize the computational expense of processing inputs using machine learning models, such as large neural network models, to ensure that the use of such models operate more efficiently.

### SUMMARY

One embodiment presented in this disclosure provides a method, including accessing a first input and a second input, generating a first embedding for the first input using a binding network, generating a second embedding for the second input using the binding network, aggregating the first and second embeddings to generate a combined embedding, applying a transformation function to the combined embedding to generate a transformed combined embedding, processing the transformed combined embedding, using an unbinding network, to extract a first transformed embedding for the first input and a second transformed embedding for the second input, applying an inference function to the first transformed embedding to generate a first output, and applying the inference function to the second transformed embedding to generate a second output.

Other embodiments in this disclosure provide non-transitory computer-readable mediums containing computer program code that, when executed by operation of one or more computer processors, performs operations in accordance with one or more of the above methods, as well as systems comprising one or more computer processors and one or more memories containing one or more programs that, when executed by the one or more computer processors, perform an operation in accordance with one or more of the above methods.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example computing environment for the execution of at least some of the computer code involved in performing the inventive methods.

FIG. 2 depicts an example workflow for the operation of a multiple-input-multiple-output (MIMO) machine learning (ML) model, according to some embodiments of the present disclosure.

FIGS. 3A-3B depict an example workflow for multiple-input binding, bundling, and unbinding in a neural network system for simultaneous inference, according to some embodiments of the present disclosure.

FIG. 4 depicts an example workflow for the binding process, according to some embodiments of the present disclosure.

FIG. 5 depicts an example workflow for the unbinding process, according to some embodiments of the present disclosure.

FIGS. 6A-6B depict an example workflow for single-input binding, bundling, and unbinding in a neural network system for dynamic inference, according to some embodiments of the present disclosure.

FIG. 7 depicts an example method for multiple-input processing and multiple-output inferencing, according to some embodiments of the present disclosure.

FIG. 8 depicts an example computing device for multiple-input-multiple-output (MIMO) operations, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments herein describe a machine learning architecture configured to process multiple inputs simultaneously by exploiting computation in superposition, and generating multiple outputs by unbinding the superposed representation. In one embodiment, multiple inputs (e.g., tensors) may be provided to a neural network model, which processes the inputs using a convolutional layer. Each input tensor may then be bound with a corresponding high-dimensional key (e.g., a unique key for each input tensor), generating a key-value feature map. In some embodiments, the key-value feature map projects each input into quasi-orthogonal subspaces. These key-value feature maps may subsequently be aggregated to create a superposed feature map that captures information from all inputs. After the superposed feature map is formed, it may be passed through additional layers of the model (e.g., convolutional layers and/or non-linear activation functions), progressively transforming the data until it is flattened into a flattened feature map. At this stage, the system may reverse the initial binding operations. For example, the system may unbind the flattened feature map using a set of unbinding keys (e.g., a unique unbinding key for each input) to retrieve the processed information for each input. The unbinding process results in generation of an individual flattened feature map for each original input, which may then be processed (e.g., using one or more fully-connected layers) to generate corresponding model outputs for each input. The disclosed neural network architectures provide an efficient approach to handling multiple inputs concurrently, while maintaining a relatively high prediction accuracy and substantially reducing the computational cost of inference.

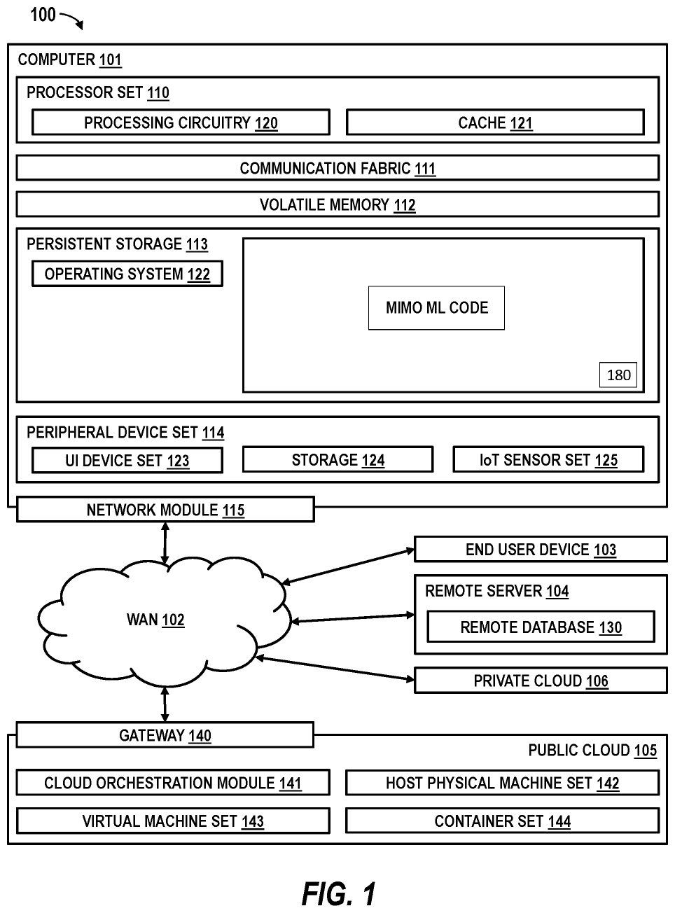

FIG. 1 depicts an example computing environment for the execution of at least some of the computer code involved in performing the inventive methods.

Computing environment 100 contains an example of an environment for the execution of at least some of the computer code involved in performing the inventive methods, such as multiple-input-multiple-output (MIMO) Machine Learning (ML) code 180. In addition to MIMO ML code 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and MIMO ML code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in MIMO ML code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in MIMO ML code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

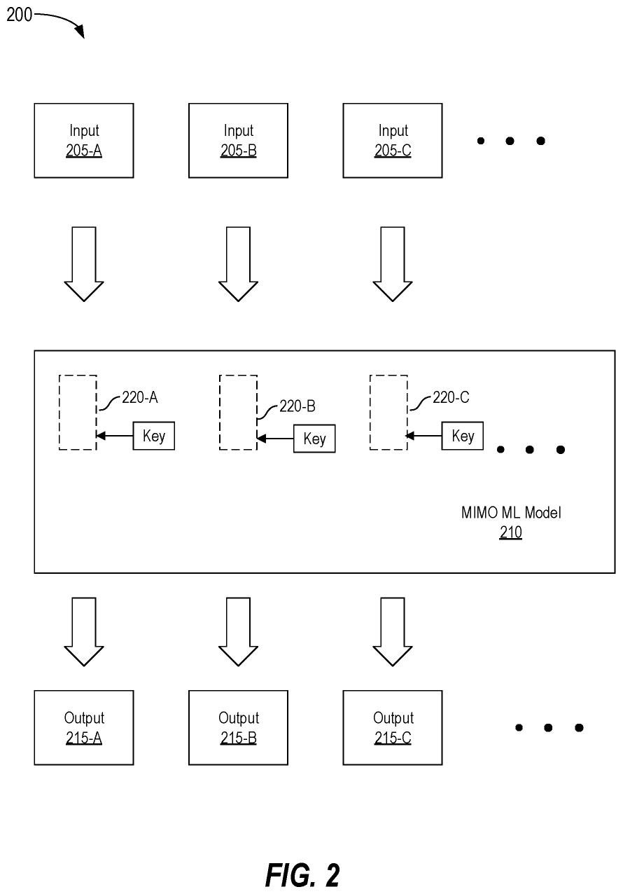

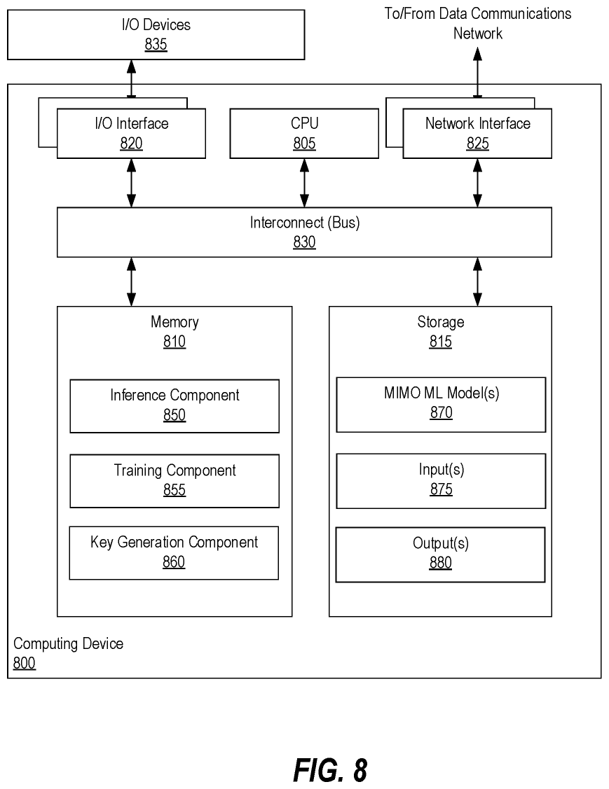

FIG. 2 depicts an example workflow 200 for the operations of a multiple-input-multiple-output (MIMO) machine learning (ML) model, according to some embodiments of the present disclosure. In some embodiments, the workflow 300 may be performed by one or more computing devices, such as the computer 101 as illustrated in FIG. 1, and/or the computing device 800 as illustrated in FIG. 8.

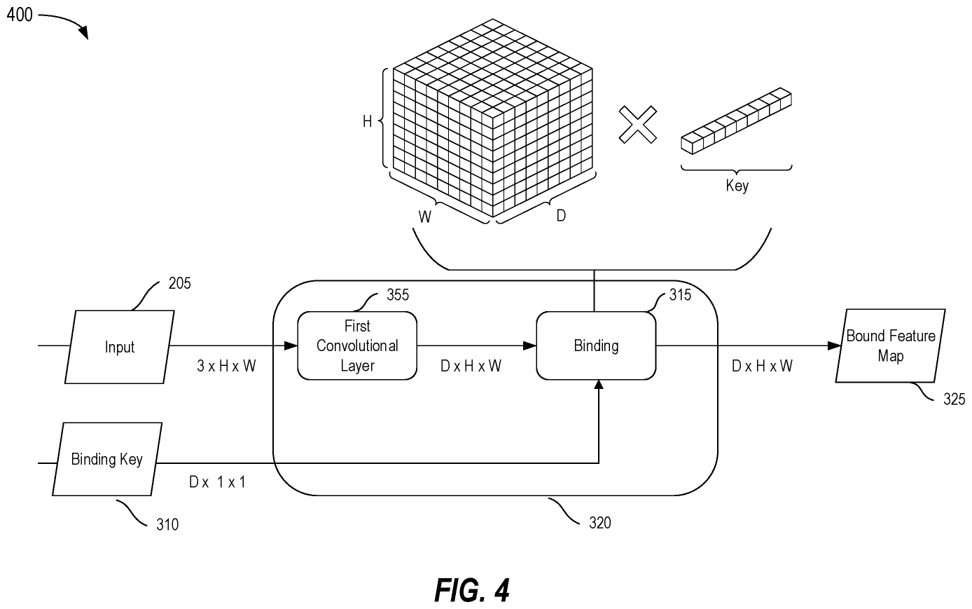

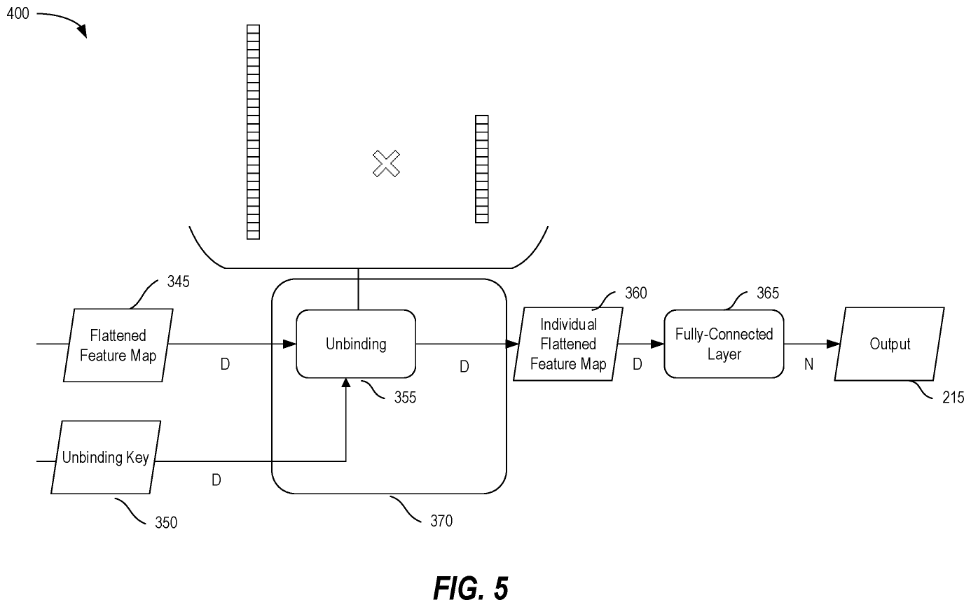

In the illustrated example, the multiple-input-multiple-output (MIMO) machine learning (ML) model 210 is trained to process multiple inputs simultaneously to generate multiple outputs 215-A, 215-B, 215-C. The MIMO ML model 210 is configured with N distinct input channels, where each channel represents an individual pathway through which the model 210 receives one of the N different inputs 205. For example, as illustrated, when the MIMO ML model 210 is trained with three input (e.g., N=3) channels, the first input 205-A is received through the first channel 220-A, and an output 215-A corresponding to the first input is generated; the second input 205-B is received through the second channel 220-B, and an output 215-B corresponding to the second input is generated; and the third input 205-C is received through the second channel 220-C, and an output 215-C corresponding to the third input is generated. In some embodiments, a channel-specific key may be assigned to each input channel, in order to track the individual processed information, ensuring that each input is properly and accurately linked to its corresponding output. More detail is discussed below with reference to FIGS. 4 and 5. The depicted embodiment of configuring the model with three (e.g., N=3) input channels is only for conceptual clarity. In some embodiments, the model may be trained to have any number of channels, including one, to process any number of inputs in parallel, depending on the specific requirements or preferences for the task at hand, the nature of the input data, and/or the computational resources available.

In some embodiments, the MIMO ML model 210 may comprise a convolutional neural network (CNN). The MIMO ML model 210 may generally be trained to perform a variety of prediction tasks. In some embodiments of the present disclosure, image recognition is used as one example task that the MIMO ML model 210 may be trained to perform. In some embodiments, the inputs may comprise various images. For example, the first input 205-A may include an image of a cat, the second input 205-B may include an image of a dog, and the third input 205-C may include an image of a bird. Multiple inputs 205 are provided simultaneously to the MIMO ML model 210, resulting in multiple outputs 215 in parallel. In some embodiments, for image recognition tasks, the outputs may include classifying the input images into different classes. For example, if the system has animal classes such as “cat,” “dog,” and “bird.” The first image may be labeled as “cat,” the second image may be labeled as “dog,” and the third image may be labeled as “bird.” In some embodiments, the outputs for these image inputs may include text identifiers that represent the primary subject of the images. For example, the output 215-A for the first input (the cat image) may be text and/or a classification corresponding to “cat,” the second output 215-B for the second input (the dog image) may be text and/or a classification corresponding to “dog,” and the third output 215-C for the third input (the bird image) may be text or another classification corresponding to “bird.”

In some embodiments, as discussed in more detail below with reference to FIGS. 4 and 5, the MIMO ML model 210, upon receiving multiple inputs (e.g., 205-A, 205-B, and 205-C) to be processed in parallel, may bind each input with a channel-specific binding key to generate a bound tensor, combine the bound tensors for each input to a combined tensor, process the combined tensor (effectively processing each input simultaneously), and unbind the processed result using channel-specific unbinding keys to get the separate outputs (e.g., 215-A, 215-B, and 215-C.

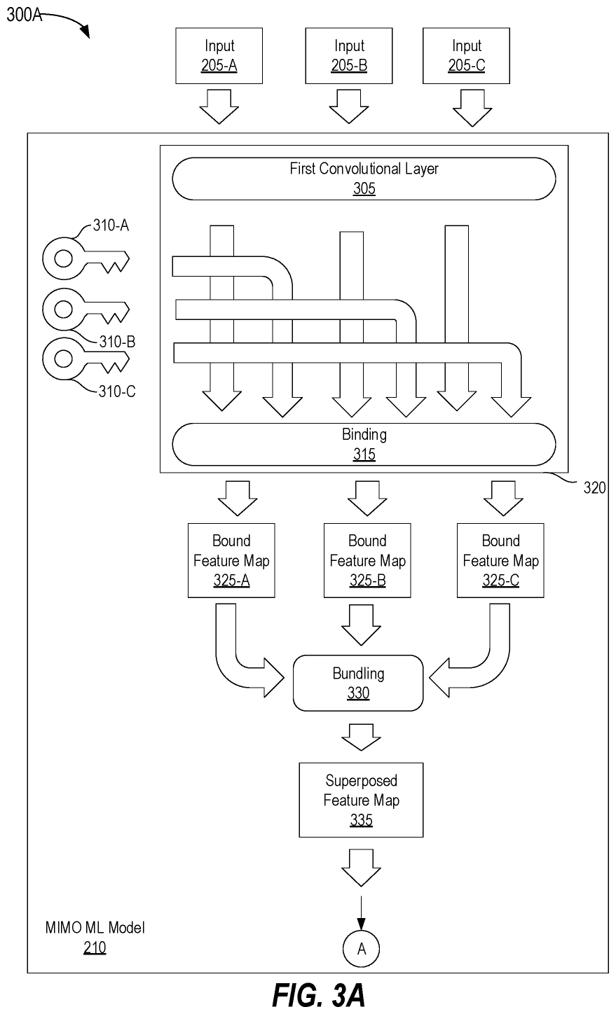

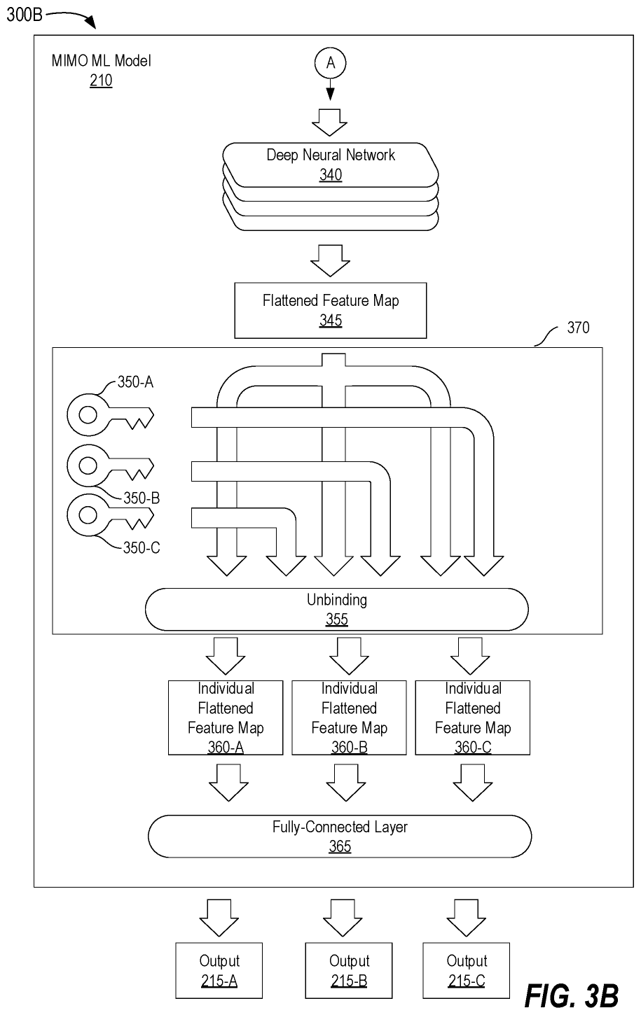

FIGS. 3A-3B depict example workflows for multiple-input binding, bundling, and unbinding in a neural network system for simultaneous inference, according to some embodiments of the present disclosure. In some embodiments, the workflow 300A of FIG. 3A and the workflow 300B of FIG. 3B (collectively, forming a workflow 300) may be performed by one or more computing devices, such as the computer 101 as illustrated in FIG. 1, and/or the computing device 800 as illustrated in FIG. 8.

In the illustrated example, the MIMO ML model 210 is trained with three (e.g., N=3) input channels. The three input channels correspond to three different inputs 205-A, 205-B, and 205-C, all of which are processed simultaneously for inference. This approach may lead to a faster processing model where multiple inputs may be processed and inferred simultaneously, without consuming additional computational resources or incurring extended processing times. The illustrated MIMO ML model 210 is configured to minimize (or at least reduce) redundant operations and maximize (or at least increase) parallel processing capabilities, ensuring optimal (or at least improved) performance.

Although the illustrated example depicts a model with three (e.g., N=3) input channels, the depicted model is only provided for conceptual clarity. In some embodiments, the model may be trained and/or configured to have any number of input channels (including one), depending on the specific requirements and preferences for the task at hand, the nature of the input data, and/or the computational resources available.

In the illustrated example, the three inputs 205-A, 205-B, and 205-C are directed to a shared binding network 320, passing through a first convolutional layer 305 within the network 320. In some embodiments, each input may comprise an image. In some embodiments, the first convolutional layer 305 may apply a set of filters or kernels (e.g., D) that slide across each image input 205 (e.g., represented by a tensor of 3×H×W, which corresponds to three depth channels (e.g., three colors), a height of H, and a width of W). In some embodiments, each kernel is used to detect specific spatial features or patterns in the inputs. Based on the detected patterns or features, the first convolutional layer 305 may transform the original image (e.g., 3×H×W) into a multi-dimensional feature map (e.g., having dimensionality D×H×W) that encodes the information present in the input, as discussed in more detail in FIG. 4.

In the illustrated example, after passing through the first convolution layer, each input 205 (e.g., the resulting feature maps from each input) is provided to the binding layer 315, through which each input 205 (or the feature map generated based on each input) is bound with a respective unique key 310. As used herein, the binding operation may be represented as ⊙. For example, the feature map generated based on input 205-A (e.g., x⁽¹⁾) is bound with the key 310-A (e.g., a⁽¹⁾) to generate a key-value pair 325-A (also referred to in some embodiments as a bound feature map or embedding) (e.g., x⁽¹⁾⊙(a⁽¹⁾), the feature map generated based on the input 205-B (e.g., x⁽²⁾) is bound with the key 310-B (e.g., a⁽²⁾) to generate a key-value pair 325-B (e.g., x⁽²⁾⊙a⁽²⁾), and the feature map generated based on the input 205-C (e.g., x⁽³⁾) is bound with the key 310-C (e.g., a⁽³⁾) to generate a key-value pair 325-C (e.g., x⁽³⁾⊙a⁽³⁾).

In some embodiments, each input channel may be assigned a unique binding key 310. The unique binding key 310 may allow for tracking the individual-processed information for each input (e.g., 205-A, 205-B, and 205-C) when multiple inputs 205 concurrently pass through the model, parameterized by neural network weights, in a superposed manner. That is, the first binding key 310-A may be used for all inputs received via the first channel (e.g., input 205-A), the second binding key 310-B may be used for all inputs received via the second channel (e.g., input 205-B), and the third binding key 310-C may be used for all inputs received via the third channel (e.g., input 205-C). By utilizing the unique channel-specific binding keys, the individual-processed information for each input may then be retrieved from the superposition through unbinding operations.

In some embodiments, the binding keys 310 may be drawn randomly at initialization. In some embodiments, the binding keys 310 may remain fixed through the model training phase. In some embodiments, the binding keys 310 may be learned and fine-tuned based on the training data during model training, which may further improve the accuracy of the model.

In some embodiments, the keys 310 may be quasi-orthogonal with high probability. As a result, binding (( ) the inputs with random (and, in some cases, high-dimensional) keys 310 may yield quasi-orthogonal key-value pairs 325 (e.g., x⁽¹⁾⊙a⁽¹⁾, x⁽²⁾⊙a⁽²⁾, and x⁽³⁾⊙a⁽³⁾) (also referred to in some embodiments as bound feature maps), which can be superposed for joint or simultaneous inference. Depending on the specific requirements of the models being used (or other preferences), a variety of binding techniques may be used. In some embodiments (such as when the inputs are images with spatial features (e.g., 2D or 3D images)) circular convolution may be utilized to bind each input image 205 to the respective key 310 associated with the channel or index of the input. The circular convolution may ensure that the key information is embedded into the input, while preserving the original structure and inherent patterns of the input. When appropriate inverse operations are applied (e.g., unbinding operations 355), the integrated key-value pair 325 may be unbounded.

In the illustrated example, the key-value pairs 325 (e.g., x⁽¹⁾⊙a⁽¹⁾, x⁽²⁾⊙a⁽²⁾, and x⁽³⁾⊙a⁽³⁾) (also referred to in some embodiments as bound feature maps) are directed to the bundling layer 330. Within this layer, the key-value pairs 325 are aggregated to create a superposed feature map 335 (also referred to in some embodiments as a combined embedding). In some embodiments, the aggregation process may be represented or performed using equation 1 below, where s is the superposed feature map 335, and x⁽¹⁾, x⁽²⁾, x⁽³⁾, a⁽¹⁾, a⁽²⁾, and a⁽³⁾ are defined as above.

$$s = {x}^{( 1 )} {a}^{( 1 )} + {x}^{( 2 )} {a}^{( 2 )} + {x}^{( 3 )} {a}^{( 3 )} \qquad Equation 1$$

In some embodiments, the superposed feature map 335 may serve as a consolidated representation of all inputs. In some embodiments, the superposed feature map 335 may capture the information encapsulated within each key-value pair 325 while preserving the dimensionality of the inputs. As discussed above, in some embodiments, binding (⊙) the inputs with random high-dimensional keys may yield quasi-orthogonal key-value pairs. The quasi-orthogonal key-value pairs may then be superposed with low interference, producing a dimensionality-preserving composition (e.g., having dimensionality D×H×W) with information on all inputs.

In some embodiments, the key-value pairs 325 may be superposed using an element-wise sum. Through the element-wise sum operation, the corresponding elements from each of the key-value pairs 325 are summed together, producing a superposed feature map 335 that retains the same dimensionality (e.g., having dimensionality D×H×W) as the individual key-value pairs 325.

In some embodiments, the bundling operator may be implemented by defining randomly initiated (but fixed during training and inference) selection masks. In some such embodiments, for each element in the superposed feature map 335, the mask(s) are used to decide or determine which key-value pairs 325 should be used to provide the specific element. The structure of these masks may vary. For example, in some embodiments, individual values in the mask may be independently and identically distributed (i.i.d.). In some embodiments, instead of each value being independent of the other, values in the mask may depend on other values within the same channel, exhibiting a channel-wise dependency.

Turning to FIG. 3B, in the illustrated example, the superposed feature map 335 is then passed through the main layers of the deep neural network 340 (also referred to in some embodiments as a transformation function). In some embodiments, the main layers of the deep neural network 340 may apply a series of filters and/or transformations to further refine or update the data within the superposed feature map 335. In some embodiments, the main layers of deep neural network 340 may include additional convolutional layers, where each convolutional layer applies convolution operations on the superposed feature map 335 using a set of filters or kernels. Each filter may be trained to recognize and extract features from the superposed feature map 335, resulting in new or updated feature maps. In some embodiments, when the model is configured for image processing, the convolutional layers may include kernels such as to detect edges, color gradients, or textures of these image inputs. In some embodiments, the kernels within the convolutional layer may adjust their weights (values) during the model training process. The weights (values) within each kernel may be set randomly when initializing the neural network, and may be adjusted, using backpropagation and optimization algorithms, to minimize errors and detect features that are relevant to the specific task the model is designed for. In some embodiments, the main layers of deep neural network 340 may include non-linear activation functions, applied immediately after one or more of the convolutional layers. The combination of non-linear activation functions and linear convolutional layers allows the network to capture more complex, non-linear relationships in the input data. In some embodiments, the non-linear activation functions may include the Rectified Linear Unit (ReLU). In some embodiments, variants of the ReLU, such as Parametric ReLU, Leaky ReLU, Shifted ReLU, may be used. In some embodiments, an isometric regularization is used to fine-tune the weights within each kernel. The isometric regularization, along with the use of Parametric ReLU activation functions, may ensure that the deep neural network 340 is inner-product preserving, where the quasi-orthogonality inherent in the superposed feature map 335 is maintained when the superposed feature map 335 is navigated through a series of layers of the deep neural network 340. The isometric convolutional layers may guarantee that the unique attributes and characteristics of individual features within the superposed map are not lost or distorted during the deep learning process.

In some embodiments, following the series of convolutional layers and activation functions, the main layers of the deep neural network 340 may further include a flatten layer. The flatten layer is responsible to transforming the multi-dimensional superposed feature map 335 into a flattened feature map 345 (e.g., a one-dimensional vector, a two-dimensional tensor, and the like) (also referred to in some embodiments as transformed combined embedding), which is a suitable format for input into subsequent fully connected layers 365 (also referred to in some embodiments as an inference function) for further processing and final predictions. Though the illustrated example depicts use of a fully-connected layer 365 (e.g., to facilitate generation of categorical predictions), in embodiments, other inferencing functions may be used (e.g., to generate regression predictions for each input).

In the illustrated example, after passing through the deep neural network 340, the multi-dimensional superposed feature map 335 (e.g., having dimensionality D×H×W) is thereby transformed into a flattened feature map 345 (e.g., having dimensionality D×1×1). The flattened feature map 345 retains the information from the superposed feature map, and is compatible with the fully connected layers 365 for further processing. The flattened feature map 345 is then directed to a shared unbinding network 370, which comprises an unbinding layer 355. Within the unbinding layer 355, unbinding operations may be applied to the flattened feature map 345 to retrieve individual-processed information for each original input 205. As illustrated, the unbinding operations include pairing the flattened feature map 345 with different unbinding keys 350-A, 350-B, and 350-C, each assigned to a specific input channel. Using the unbinding layer 355, individual flattened feature maps 360-A, 360-B, and 360-C (also referred to in some embodiments as transformed embeddings or unbound tensors) are generated from the superposed flattened feature map 345. Each of the individual flattened feature maps generated may correspond to an original input index. For example, individual flattened feature map 360-A may comprise individual-processed information from input 205-A, individual flattened feature map 360-B may comprise individual-processed information from input 205-B, and individual flattened feature maps 360-C may comprise individual-processed information from input 205-C.

The unbinding process may be represented or defined using equations 2 and 3 below.

$${\tilde{a}}^{( 1 )} {f}_{θ} ( s ) \approx {\tilde{a}}^{( 1 )} {f}_{θ} ( {a}^{( 1 )} {x}^{( 1 )} ) + {\tilde{a}}^{( 1 )} {f}_{θ} ( {a}^{( 2 )} {x}^{( 2 )} ) \qquad Equation 3$$

As indicated in equation 2, unbinding the flattened feature map 345 (e.g., the result of processing the superposed feature map 335 (s) using the deep neural network 340, as indicated by f_{θ}(s)) using the unbinding key 350-A (given by ã⁽¹⁾, where [symbol] represents the unbinding operation) yields a value that is equal to (or approximately equal to) f_{θ} (a⁽¹⁾⊙x⁽¹⁾) (e.g., the result of processing the feature map 325-A using the deep neural network 340) unbound using the unbinding key 350-A, summed with f_{θ}(a⁽²⁾⊙x⁽²⁾) (e.g., the result of processing the feature map 325-B using the deep neural network 340) unbound using the unbinding key 350-A. As indicated below in equation 3, equation 2 can be simplified to facilitate understanding of how the individual flattened feature maps 360 can be extracted from the flattened feature map 345.

$${\tilde{a}}^{( 1 )} {f}_{θ} ( s ) \approx {f}_{θ} ( {x}^{( 1 )} ) + {\tilde{a}}^{( 1 )} {f}_{θ} ( {a}^{( 2 )} {x}^{( 2 )} ) \qquad Equation 3$$

As indicated in equation 3, unbinding the flattened feature map 345 (f_{θ}(s)) using the unbinding key 350-A (ã⁽¹⁾) yields a value that is equal to (or approximately equal to) f_{θ}(x⁽¹⁾) (e.g., the result of processing the feature map from input 205-A using the deep neural network 340 directly, without binding) plus some amount of noise or error (given as ã⁽¹⁾ [symbol] f_{θ}(a⁽²⁾⊙x⁽²⁾) in equation 3).

Although this added noise may result in somewhat reduced prediction accuracy in some embodiments, the loss in accuracy is generally small, and is balanced by the significant computational efficiency gains yielded by simultaneous processing of the bound data. In some embodiments, using few input channels or indices (e.g., training a model to use three inputs in parallel, as compared to training the model to use ten inputs in parallel) will generally result in reduced noise in the output predictions. However, using additional channels or indices will generally result in improved computational efficiency (e.g., because more inputs can be processed in parallel).

Notably, equations 2 and 3 above provide formulas for unbinding when two inputs are used (e.g., for a model trained to use two input indices: one for input 205-A and one for input 205-B) for conceptual clarity. The same approach can similarly be used when additional input indices are used. Additionally, though equations 2 and 3 describe unbinding operations using a first unbinding key 350-A to yield a first individual flattened feature map 360-A for conceptual clarity, the same approach may be used to generate or recover each other flattened feature map for each other input.

In some embodiments, the unbinding keys 350 may be randomly initialized (e.g., at the start of the training process) and may remain fixed during training and inference (in a similar manner to the binding keys, as discussed above). In some embodiments, the unbinding keys 350 may be trained during training (in addition to or instead of training the binding keys 310) while the neural network model is trained. Such a training process may ensure that, the individual-processed information for each input can be retrieved from the superposed representation with minimal loss or distortion. In some embodiments, each combination of a binding key 310 and its corresponding unbinding key 350 may establish a protected channel for a specific input, ensuring the input's integrity as it is superposed and passed through the nonlinear transformation of the deep neural network.

In the illustrated example, after the unbinding process, the individual flattened feature maps 360-A, 360-B, and 360-C are then provided to a fully-connected layer 365 for final prediction. In some embodiments, the fully-connected layer 365 processes the individual flattened feature maps 360-A, 360-B, and 360-C independently, and generates the final outputs 215-A, 215-B, and 215-C. The exact nature of the outputs 215 may depend on the design of the fully-connected layer 365 and the specific task the MIMO ML model is designed to perform. In some embodiments, the final outputs 215 may include categorizing the input images into different classes. In some embodiments, the final outputs 215 may include generating text that describes the content of each image.

In this way, using the MIMO architecture, the vast majority of computational operations and expense is used to process superposed data (e.g., within the deep neural network 340), and the data for each input need only be processed separately using operations with relatively low computational expense (e.g., in the binding network 320, bundling layer 330, unbinding network 370, and fully-connected layer 365). This substantially reduces the computational expense of processing inputs using the architecture, as discussed above.

FIG. 4 depicts an example workflow 400 for the binding process, according to some embodiments of the present disclosure. In some embodiments, the workflow 400 may be performed by one or more computing devices, such as the computer 101 as illustrated in FIG. 1, and/or the computing device 800 as illustrated in FIG. 8.

In the illustrated example, a shared binding network 320 comprises a first convolutional layer 355 and a binding layer 315. The shared binding network 320 integrates each input 205 with the corresponding binding key 310 of the input index, and outputs a key-value pair 325 (also referred to in some embodiments as a bound feature map). In some embodiments, the input 205 may include an image with three color channels (e.g., an RGB image). In some embodiments, the input image 205 may be represented as a tensor of 3×H×W, which corresponds to three color channels, a height of H, and a width of W. In the illustrated example, the input image 205 with dimensions 3×H×W is passed through the first convolutional layer 355 with D filters or kernels, generating a feature map with dimensions D×H×W.

In the illustrated example, the binding key 310 is a vector with dimensions D×1×1. The binding key 310 is combined with the feature map through the binding layer 315. In some embodiments, the binding layer 315 corresponds to use of circular convolution using the binding key 310. For example, in some embodiments, N binding keys (corresponding to N input indices), each with dimensions D×1×1, may be drawn from an independently and identically distributed Gaussian distribution with zero mean and 1/D variance. For each input index, the binding operation may be implemented by applying circular convolution between the corresponding binding key 310 and each pixel volume spanning across the feature map depth (e.g., having dimensionality D×1×1). In some embodiments, this binding operation may be referred to as position-wise holographic reduced representation (PWHRR). In some embodiments, the binding operation may maintain the local structure of each image input, which may be useful for the subsequent deep CNN layers with limited local receptive field. In some embodiments, the binding keys 310 may be randomly initialized and assigned to each input channel or index during the initial phase of model training. In some embodiments, the binding keys 310 may be fixed during the model training process. In some embodiments, the binding keys 310 may be learned and fine-tuned based on training data, potentially improving the accuracy of the binding and subsequent unbinding operations. In the illustrated example, the shared binding network 320 generates a feature map 325 with dimensions D×H×W, which represents a combination of the input 205 with its corresponding binding key 310. In some embodiments, the feature map 325 for each input may be superposed and passed through the rest of the neural network layers.

FIG. 5 depicts an example workflow 500 for the unbinding process, according to some embodiments of the present disclosure. In some embodiments, the workflow 500 may be performed by one or more computing devices, such as the computer 101 as illustrated in FIG. 1, and/or the computing device 800 as illustrated in FIG. 8.

In the illustrated example, a shared unbinding network 370 comprises an unbinding layer 355. The shared unbinding network 370 unbinds the flattened feature map 345 using unbinding key(s) 350, and outputs one or more individual flattened feature maps 360, each corresponding to a respective original input (e.g., 205 of FIG. 2). In some embodiments, the unbinding network 355 uses a circular correlation operation between the flattened feature map 345 and the unbinding key 350. In some embodiments, the unbinding operation may be performed before the flattening operation, where the output of the deep neural network (e.g., 340 of FIG. 3B) is a multi-dimensional superposed feature map with dimensions D×H×W. In such a configuration, the shared unbinding network 370 unbinds the multi-dimensional superposed feature map using unbinding key(s) with dimensions D×1×1.

In the illustrated embodiments, the flattened feature map 345 may be represented as a column vector with D rows. In the illustrated example, each unbinding key 350 is a column vector with dimensions D×1×1. In some embodiments, when a MIMO ML model is configured with multiple input channels or indices (e.g., N=3), each channel may be assigned a channel-specific binding key (e.g., 310 of FIG. 3). The channel-specific binding key allows for tracking the individual-processed information through the neural network processing. In some embodiments, the unbinding key 350 may comprises a trained value learned during training (e.g., based at least in part on the value of the corresponding binding key). In some embodiments, the values for the unbinding keys may be trained during the training phase of the neural network. In some embodiments, the training process may ensure a synergistic relationship between the binding key and the unbinding key for the same input channel, allowing for effective decoding of the superposed representation to recover the individual-processed information with minimal loss or distortion.

In the illustrated example, the individual flattened feature map 360 with dimensions D×1×1 is then directed to a fully-connected layer 365, which applies a weighted sum across the elements within the flattened feature map (e.g., along with a bias term) and outputs a vector with N values. In some embodiments, when the neural network is designed to classify the input images into 10 classes, the fully-connected layer 365 may output a vector with 10 values, and each value represents the probability of the input image belonging to a specific class among the 10 classes. The class with the highest value in this probability distribution may then be determined as the predicted class of the input image.

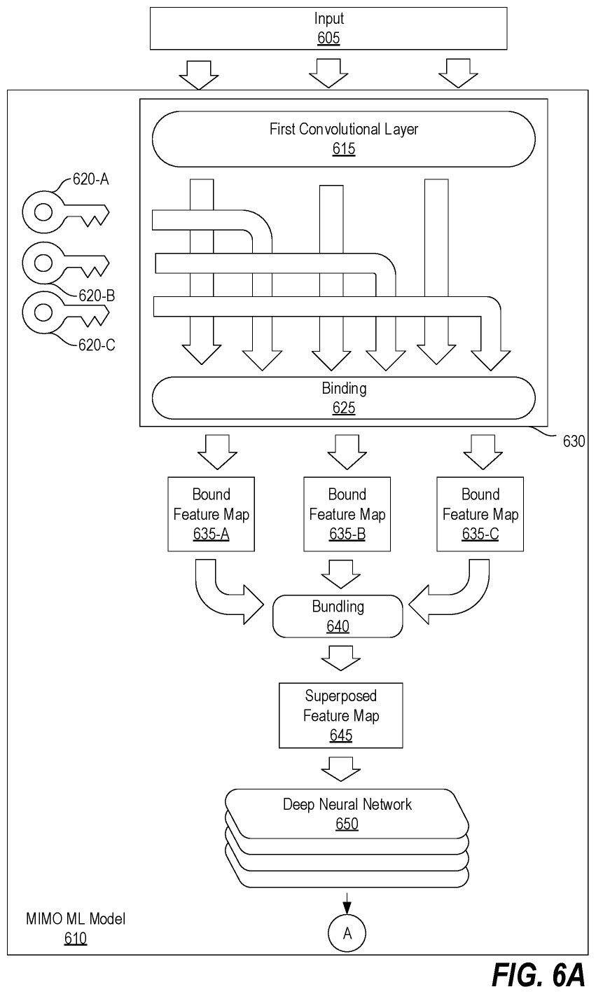

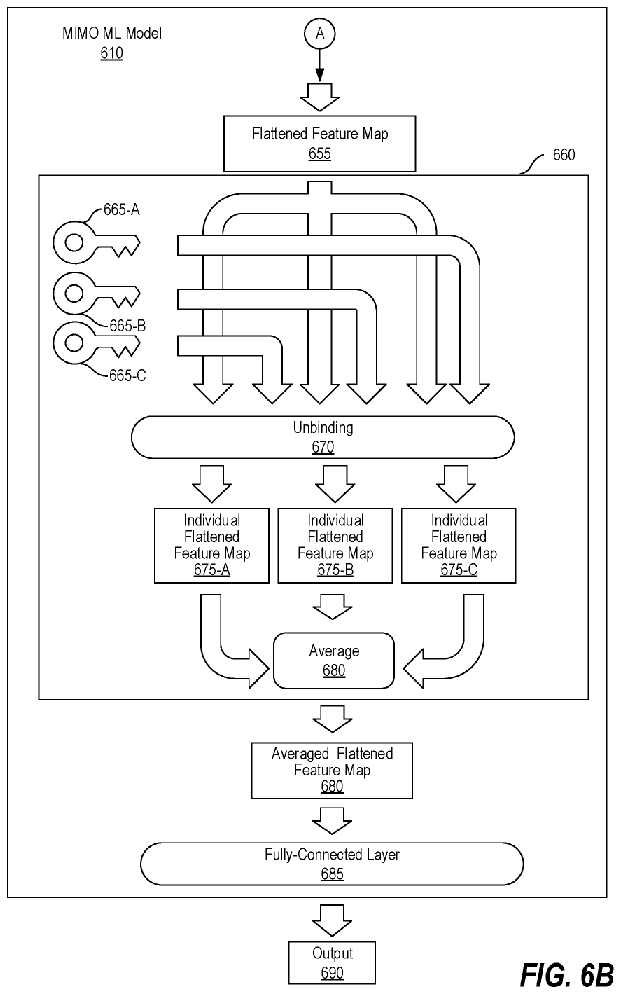

FIGS. 6A-6B depict an example workflow for single-input binding, bundling, and unbinding in a neural network system for dynamic inference, according to some embodiments of the present disclosure. In some embodiments, the workflow 600A of FIG. 6A and the workflow 600B of FIG. 6B (collectively, forming a workflow 600) may be performed by one or more computing devices, such as the computer 101 as illustrated in FIG. 1, and/or the computing device 800 as illustrated in FIG. 8.

In the illustrated example, the MIMO ML model 610 is trained with three (e.g., N=3) input channels, as discussed above. Instead of using the channels for different inputs, in the illustrated example, all three input channels are used for the same input 605 for dynamic inference. This approach may generate a more accurate prediction for the input 605, where individual-processed information is averaged to form an in-network ensemble.

The depicted embodiment of configuring the model with three (e.g., N=3) input channels is only for conceptual clarity. In some embodiments, the model may be trained and/or configured to be dynamic and capable of running a superposition of one up to N different inputs by inserting the same input into multiple channels (rather than processing each index as a separate input) and averaging the results, the system can effectively form an in-network ensemble that allows the single input 605 to be processed more accurately (as compared to when multiple inputs are processed in parallel).

In the illustrated example, the input 605 is provided to a shared binding network 630, passing through the first convolutional layer 615 within the binding network 630. In some embodiments, the input may comprise an image with 3 color channels (e.g., a standard RGB image) and may be represented as a tensor of 3×H×W. The first convolutional layer 615 may apply D filters or kernels to the input image, and transform it into a multi-dimensional feature map (e.g., having dimensionality D×H×W). In some aspects, the binding network 630 generally corresponds to the binding network 320 of FIG. 3A, and performs similar (or identical) operations.

In the illustrated example, after passing through the first convolution layer 615, the input 605 (e.g., having dimensionality D×H×W) is then bound with three distinct binding keys 620-A, 620-B, and 620-C, where each key is assigned to a specific input channel. In some embodiments, the binding keys 620 may be randomly initialized, as discussed above. In some embodiments, the binding keys 620 may be fixed during the model training process. In some embodiments, the binding keys 620 may be learned and fine-tuned during the model training process. In some embodiments, the binding operation may be achieved by applying circular convolution between the input 605 and each channel-specific binding key 620-A, 620-B, and 620-C.

In the illustrated example, the outputs of the binding layer 625 are three distinct bound feature maps 635-A, 635-B, and 635-C (also referred to in some embodiments as key-value pairs), each representing a combination of the input 605 with a respective binding key 620. The three feature maps 635 are then directed to the bundling layer 640, within which the three feature maps 635 are aggregated to form a superposed representation 645 (also referred to in some embodiments as a superposed feature map or a combined embedding). In some aspects, the bundling layer 640 generally corresponds to the bundling layer 330 of FIG. 3A, and performs similar (or identical) operations.

In the illustrated example, the superposed feature map 645 is then passed through the main layers of the deep neural network 650 (also referred to in some embodiments as a transformation function). In some embodiments, the main layers of deep neural network 650 may include a series of convolutional layers that apply additional convolution operations to the superposed feature map 645, in order to recognize and extract additional various features. In some embodiments, isometric regularization may be deployed to regulate the weights (values) of each convolutional layer. The isometric regularization may ensure that the weights of the convolution layers do not get too far from orthogonality, thereby preserving the quasi-orthogonality inherent in the superposed feature map 645. In some embodiments, the main layers of deep neural network 340 may include non-linear activation functions (e.g., ReLU, Parametric ReLU, Leaky ReLU, Shifted ReLU), implemented immediately after each convolutional layer, ensuring the model to capture more complex, non-linear relationships in the input data. In some embodiments, following the series of convolutional layers and activation functions, the main layers of the deep neural network 650 may further include a flatten layer, which transforms the multi-dimensional superposed feature map 645 into a flattened feature map 655 (e.g., a one-dimensional vector, a two-dimensional tensor, and the like) (also referred to in some embodiments as transformed combined embedding). In some embodiments, the flattened feature map 655 may retain all the essential information from the superposed feature map 645, and be compatible with the fully connected layers 690 for further processing. In some aspects, the deep neural network 650 generally corresponds to the deep neural network 340 of FIG. 3B, and performs similar (or identical) operations.

In the illustrated example, the flattened feature map 655 is then directed to a shared unbinding network 660, which comprises an unbinding layer 670 and an average layer 680. In some aspects, the unbinding network 660 generally corresponds to the unbinding network 370 of FIG. 3B, and performs similar (or identical) operations. Within the unbinding layer 670, the flattened feature map 655 is unbound using three separate unbinding keys 665-A, 665-B, and 665-C. During the unbinding operations, three separate sets (or representations) of the individual-processed information for the same input 605 are retrieved from the superposed flattened feature map 655. As such, the outputs of the unbinding layer 670 are three individual flattened feature maps 675-A, 675-B and 675-C (also referred to in some embodiments as transformed embeddings or unbound tensors). In some embodiments, each individual flattened feature map may capture different aspects or features of the input data (e.g., an image), and retain a distinct version of individual-processed information for the input data.

As illustrated, after passing through the unbinding layer 370, the three individual flattened feature maps 675-A, 675-B and 675 are then provided to an averaging layer 680, within which the three individual flattened feature maps are averaged to create an averaged flattened feature map 685. In some embodiments, the average operations may include performing an element-wise addition of each element in the feature maps and dividing each resulting value by three (or N, in the case of N input indices). In some embodiments, the averaged flattened feature map 685 may integrate information from all three individual feature maps 675-A, 675-B, and 675-C, and potentially reduce the variance or noise inherent in each individual map, thereby improving the predictive accuracy of the MIMO ML model 610.

In the illustrated example, the fully-connected layer 690 (also referred to in some embodiments as an inference function) receives the averaged flattened feature map 685, and processes it to produce a final output 695. In some embodiments, the final output 695 may include categorizing the input images into different classes. In some embodiments, the final output 695 may include generating text that describes the content of each image.

In some embodiments, the averaging layer 680 may be selectively or dynamically used during inferencing. That is, the model may be trained to operate on N input samples in parallel (using superposition, as discussed above). During inferencing, the system may optionally process N inputs in parallel (as discussed above), or may selectively or dynamically process fewer inputs (e.g., processing a single input, or N/2 inputs). For example, if a single prediction for a single input is desired, the system may use averaging layer 680 to aggregate all of the individual flattened feature maps 675.

The averaging layer 680 may similarly be used to process a different number of samples using the model. For example, suppose a first input is used for both the first and second input indices (e.g., bound using the binding keys 620-A and 620-B), while a second input is used for the third input index (e.g., bound using the binding key 620-C). In an embodiment, the averaging layer 680 may be used to compute an averaged flattened feature map for the first two indices, while the last index may be processed as discussed above. This allows the system to use a model, trained originally to process N inputs in parallel, to dynamically process fewer than N inputs during inferencing, if desired.

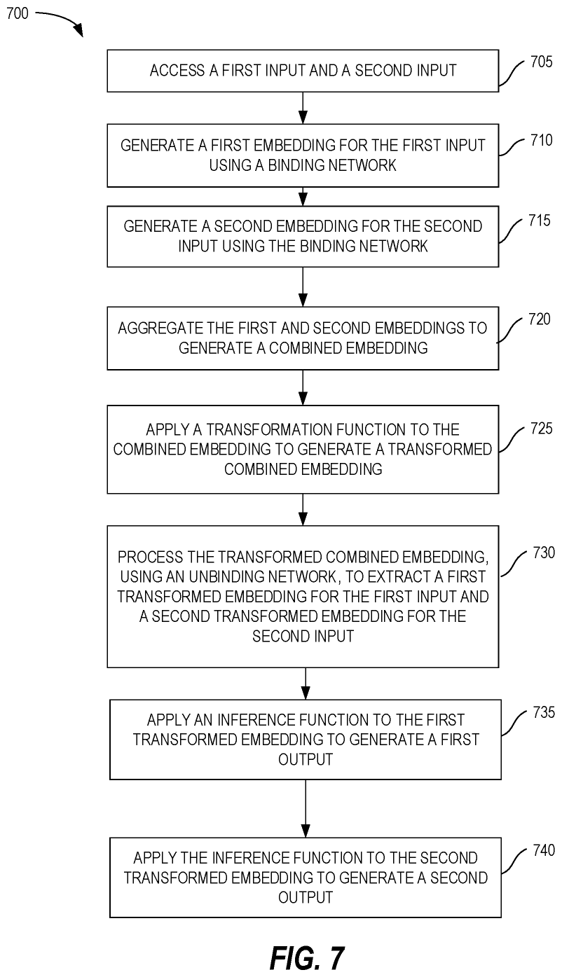

FIG. 7 depicts an example method 700 for multiple-input processing and multiple-output inferencing, according to some embodiments of the present disclosure. In some embodiments, the method 700 may be performed by one or more computing devices, such as the computer 101 as illustrated in FIG. 1, and/or the computing device 800 as illustrated in FIG. 8.

The method 700 begins at block 705, where a system (e.g., the computer 101 of FIG. 1, or the computing device 800 of FIG. 8) accesses a first input (e.g., 205-A of FIG. 2) and a second input (e.g., 205-B of FIG. 2).

At block 710, the system generates a first embedding (e.g., 325-A of FIG. 3A) (also referred to in some embodiments as bound feature map or embedding) for the first input using a binding network (e.g., 320 of FIG. 3A). In some embodiments, the first embedding may be generated by combining a binding key (e.g., 310-A of FIG. 3A) and the first input (e.g., 205-A of FIG. 3A) using the binding network (e.g., 320 of FIG. 3A). In some embodiments, the binding network (e.g., 320 of FIG. 3A) may comprise a convolutional layer (e.g., 305 of FIG. 3A) to generate a convolution output based on the first input, and a binding operator (e.g., 315 of FIG. 3A) to generate the first embedding by performing circular convolution on the first input using the binding key. In some embodiments, the first binding key (e.g., 310-A of FIG. 3A) may comprise a random value assigned while the transformation function was trained.

At block 715, the system generates a second embedding (e.g., 325-B of FIG. 3A) (also referred to in some embodiments as bound feature map or embedding) for the second input using a binding network (e.g., 320 of FIG. 3A).

At block 720, the system aggregates the first (e.g., 325-A of FIG. 3A) and second embeddings (e.g., 325-B of FIG. 3A) to generate a combined embedding (e.g., 335 of FIG. 3A) (also referred to in some embodiments as superposed feature map). In some embodiments, aggregating the first and second embeddings to form a combined embedding may comprise applying one or more masks to the first and second embeddings to extract one or more elements from the first and second embeddings, and combining the extracted elements to generate the combined embedding.

At block 725, the system applies a transformation function (e.g., 340 of FIG. 3B) to the combined embedding (e.g., 335 of FIG. 3A) to generate a transformed combined embedding (e.g., 345 of FIG. 3B). In some embodiments, the transformation function may comprise one or more convolutional layers, and one or more non-linear activation functions. In some embodiments, during training, the weights of the more convolutional layers may be trained using isometric regularization.

At block 730, the system processes the transformed combined embedding (e.g., 345 of FIG. 3B), using an unbinding network (e.g., 370 of FIG. 3B), to extract a first transformed embedding (e.g., 360-A of FIG. 3B) for the first input and a second transformed embedding (e.g., 360-B of FIG. 3B) for the second input. In some embodiments, the unbinding network (e.g., 370 of FIG. 3B) may comprise an unbinding operator (e.g., 355 of FIG. 3B) to generate an unbound tensor (e.g., 360-A, 360-B, and 360-C of FIG. 3B) based on performing circular correlation on the transformed combined embedding using the unbinding key (e.g., 350 of FIG. 3B). In some embodiments, extracting the first transformed embedding may comprise processing a first unbinding key (e.g., 350-A of FIG. 3B) and the transformed combined embedding (e.g., 345 of FIG. 3B) using the unbinding network (e.g., 370 of FIG. 3B). In some embodiments, the first unbinding key (e.g., 350-A of FIG. 3B) may comprise a trained value learned while the transformation function (e.g., 340 of FIG. 3B) was trained.

At block 735, the system applies an inference function (e.g., 365 of FIG. 3B) to the first transformed embedding (e.g., 360-A of FIG. 3B) to generate a first output (e.g., 215-A of FIG. 3B).

At block 740, the system applies the inference function (e.g., 365 of FIG. 3B) to the second transformed embedding (e.g., 360-B of FIG. 3B) to generate a second output (e.g., 215-B of FIG. 3B).

In some embodiments, the system may access a third input (e.g., 605 of FIG. 6A). The system may generate a third embedding (e.g., 635-A of FIG. 3A) for the third input using the binding network (e.g., 630 of FIG. 6A). The system may generate a fourth embedding (e.g., 635-B) for the third input using the binding network. The system may aggregate the third (e.g., 635-A of FIG. 3A) and fourth embeddings (e.g., 635-B of FIG. 3A) to generate a second combined embedding (e.g., 645 of FIG. 3A). The system may apply the transformation function (e.g., 650 of FIG. 6A) to the second combined embedding (e.g., 645 of FIG. 6A) to generate a second transformed combined embedding (e.g., 655 of FIG. 6B). The system may process the second transformed combined embedding (e.g., 655 of FIG. 6B), using the unbinding network (e.g., 660 of FIG. 6B), to extract a third transformed embedding (e.g., 675-A of FIG. 6B) for the third input and a fourth transformed embedding (e.g., 375-B of FIG. 6B) for the third input. The system may average the third and fourth transformed embeddings to generate an averaged embedding (e.g., 680 of FIG. 6B). The system may apply the inference function (e.g., 690 of FIG. 6B) to the averaged embedding (e.g., 680 of FIG. 6B) to generate a third output (e.g., 695 of FIG. 6B).

FIG. 8 depicts an example computing device 800 for multiple-input-multiple-output (MIMO) operations, according to some embodiments of the present disclosure. Although depicted as a physical device, in embodiments, the computing device 800 may be implemented using virtual device(s), and/or across a number of devices (e.g., in a cloud environment). The computing device 800 can be embodied as any computing device, such as the computer 101 as illustrated in FIG. 1.

As illustrated, the computing device 800 includes a CPU 805, memory 810, storage 815, one or more network interfaces 825, and one or more I/O interfaces 820. In the illustrated embodiment, the CPU 805 retrieves and executes programming instructions stored in memory 810, as well as stores and retrieves application data residing in storage 815. The CPU 805 is generally representative of a single CPU and/or GPU, multiple CPUs and/or GPUs, a single CPU and/or GPU having multiple processing cores, and the like. The memory 810 is generally included to be representative of a random access memory. Storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, memory 810, storage 815, network interface(s) 825, and I/O interface(s) 820 are communicatively coupled by one or more buses 830.

In the illustrated embodiment, the memory 810 includes an inference component 850, a training component 855, and a key generation component 860.

Although depicted as a discrete component for conceptual clarity, in some embodiments, the operations of the depicted component (and others not illustrated) may be combined or distributed across any number of components. Further, although depicted as software residing in memory 810, in some embodiments, the operations of the depicted components (and others not illustrated) may be implemented using hardware, software, or a combination of hardware and software.

In one embodiment, the inference component 850 may retrieve and load the trained MIMO ML Model 870 (e.g., 210 of FIGS. 3A and 3B, 610 of FIGS. 6A and 6B) from the storage 815. The inference component 850 may activate the model by setting up all the learned keys, weights, bias, and/or other parameters of the model, making it ready to evaluate incoming data. Upon activation, the inference component 850 may receive and process multiple inputs concurrently using the trained MIMO ML Model 870. In some embodiments, the input may include images (e.g., 2D or 3D), video frames, or other visual data formats for the trained MIMO ML model 870. The inference component 850 may ensure that each input is properly processed, superposed, and passed through the various layers and functions of the model, ultimately generating corresponding outputs. In some embodiments, the outputs of the trained MIMO ML model 870 may involve classifying the input images into different categories. In some embodiments, the outputs may include generating text descriptions that capture the content of each input.

In one embodiment, the training component 855 may train the MIMO ML models by feeding them vast amounts of data paired with target outputs (e.g., images with classified labels). The training process may teach the models to recognize patterns and/or features within the input data, and refine their predictions to align closely with the provided target outputs. In some embodiments, the training process may be performed iteratively, allowing the models to gradually adjust their internal parameters and converge on an optimal solution. In some embodiments, after the initial training process is complete, the training component 855 may evaluate the performance of the trained models using a validation dataset. The validation dataset may comprise new and unseen data, and is different from the training dataset. In some embodiments, the validation process may be performed after each epoch for training is completed (e.g., the model has been trained through the entire received training data records). During the validating process, the training component 855 may fine-tune the parameters of the models to achieve optimal performance (e.g., selecting the model with a specific combination of parameter values that provides the best performance on the validation dataset). By doing so, the training component 855 may monitor the performance of the models and prevent them from overfitting on the training dataset. In some embodiments, subsequent to the optimization, the training component 855 may apply a testing dataset to determine the models' performance, such as their accuracy, efficiency and/or reliability under various conditions.

In one embodiment, the key generating component 860 may generate a unique binding key (e.g., 310 of FIG. 3A) for each input channel. In some embodiments, the binding keys may be generated randomly and assigned to each input channel during the initial phase of model training. In some embodiments, the binding keys 310 may be fixed through the model training phase. In some embodiments, the binding keys 310 may be learned and fine-tuned based on the training data during model training, leading to improved accuracy of the binding and subsequent unbinding operations. In some embodiments, the key generating component 860 may randomly initialize the unbinding keys (e.g., 350 of FIG. 3B), and adjust the values of each unbinding key based on its corresponding binding key during the model's training phase. In some embodiments, the unbinding key may be trained, based on its corresponding binding key, to effectively reverse the binding operation, to accurately extract the processed information for each original input from the superposed representation.

In the illustrated example, the storage 815 may include trained MIMO ML models 870, the input data 875, and the output data 880. As discussed above, in some embodiments, the inputs 875 may include images (e.g., 2D or 3D), video frames, or other visual data formats for the trained MIMO ML model 870. The outputs 880 may involve classifying the input images into different categories, and/or generating text descriptions that capture the content of each input. In some embodiments, the aforementioned information may be saved in a remote database that connects to the computing device 800 via a network.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

While the foregoing is directed to embodiments of the present invention, other and further embodiments of the invention may be devised without departing from the basic scope thereof, and the scope thereof is determined by the claims that follow.

What is claimed is:

1. A method comprising:
accessing a first input and a second input;
generating a first embedding for the first input using a binding network;
generating a second embedding for the second input using the binding network;
aggregating the first and second embeddings to generate a combined embedding;
applying a transformation function to the combined embedding to generate a transformed combined embedding;
processing the transformed combined embedding, using an unbinding network, to extract a first transformed embedding for the first input and a second transformed embedding for the second input;
applying an inference function to the first transformed embedding to generate a first output; and
applying the inference function to the second transformed embedding to generate a second output.

2. The method of claim 1, wherein the first embedding is generated by combining a first binding key and the first input using the binding network.

3. The method of claim 2, wherein the binding network comprises:
a convolutional layer to generate a convolution output based on the first input, and
a binding operator to generate the first embedding by performing circular convolution on the first input using the binding key.

4. The method of claim 1, wherein the unbinding network comprises an unbinding operator to generate an unbound tensor based on performing circular correlation on the transformed combined embedding using an unbinding key.

5. The method of claim 1, wherein extracting the first transformed embedding for the first input comprising processing a first unbinding key and the transformed combined embedding using the unbinding network.

6. The method of claim 5, wherein the first unbinding key comprises a trained value learned while the transformation function was trained.

7. The method of claim 2, wherein the first binding key comprises a random value assigned while the transformation function was trained.

8. The method of claim 1, wherein the transformation function comprises one or more convolutional layers, and one or more non-linear activation functions.

9. The method of claim 8, wherein, during training, weights of the more convolutional layers are trained using isometric regularization.

10. The method of claim 1, wherein aggregating the first and second embeddings to form a combined embedding comprises:
applying one or more masks to the first and second embeddings to extract one or more elements from the first and second embeddings, and
combining the extracted elements to generate the combined embedding.

11. The method of claim 1, further comprising:
accessing a third input;
generating a third embedding for the third input using the binding network;
generating a fourth embedding for the third input using the binding network;
aggregating the third and fourth embeddings to generate a second combined embedding;
applying the transformation function to the second combined embedding to generate a second transformed combined embedding;
processing the second transformed combined embedding, using the unbinding network, to extract a third transformed embedding for the third input and a fourth transformed embedding for the third input;
averaging the third and fourth transformed embeddings to generate an averaged embedding; and
applying the inference function to the averaged embedding to generate a third output.

12. A system comprising:
one or more memories collectively storing computer-executable instructions; and
one or more processors configured to collectively execute the computer-executable instructions and cause the system to:
access a first input and a second input;
generate a first embedding for the first input using a binding network;
generate a second embedding for the second input using the binding network;
aggregate the first and second embeddings to generate a combined embedding;
apply a transformation function to the combined embedding to generate a transformed combined embedding;
process the transformed combined embedding, using an unbinding network, to extract a first transformed embedding for the first input and a second transformed embedding for the second input;
apply an inference function to the first transformed embedding to generate a first output; and
apply the inference function to the second transformed embedding to generate a second output.

13. The system of claim 12, wherein the first embedding is generated by combining a binding key and the first input using the binding network.

14. The system of claim 13, wherein the binding network comprises:
a convolutional layer to generate a convolution output based on the first input, and
a binding operator to generate the first embedding by performing circular convolution on the first input using the binding key.

15. The system of claim 12, wherein the unbinding network comprises an unbinding operator to generate an unbound tensor based on performing circular correlation on the transformed combined embedding using an unbinding key.

16. The system of claim 12, wherein, to aggregate the first and second embeddings to form the combined embedding, the one or more processors are configured to further collectively execute the computer-executable instructions and cause the system to:
apply one or more masks to the first and second embeddings to extract one or more elements from the first and second embeddings, and
combine the extracted elements to generate the combined embedding.

17. The system of claim 12, wherein the computer-executable instructions are executed by the one or more processors and cause the system to further:
access a third input;
generate a third embedding for the third input using the binding network;
generate a fourth embedding for the third input using the binding network;
aggregate the third and fourth embeddings to generate a second combined embedding;
apply the transformation function to the second combined embedding to generate a second transformed combined embedding;
process the second transformed combined embedding, using the unbinding network, to extract a third transformed embedding for the third input and a fourth transformed embedding for the third input;
average the third and fourth transformed embeddings to generate an averaged embedding; and
apply the inference function to the averaged embedding to generate a third output.

18. A computer program product, comprising:
a computer-readable storage medium having computer-readable program code executable to cause the computer program product to:
access a first input and a second input;
generate a first embedding for the first input using a binding network;
generate a second embedding for the second input using the binding network;
aggregate the first and second embeddings to generate a combined embedding;
apply a transformation function to the combined embedding to generate a transformed combined embedding;
process the transformed combined embedding, using an unbinding network, to extract a first transformed embedding for the first input and a second transformed embedding for the second input;
apply an inference function to the first transformed embedding to generate a first output; and
apply the inference function to the second transformed embedding to generate a second output; and
one or more processors, each processor of which is configured to execute at least a respective portion of the computer-readable program code.

19. The computer program product of claim 18, wherein the first embedding is generated by combining a binding key and the first input using the binding network.

20. The computer program product of claim 18, wherein the binding network comprises:
a convolutional layer to generate a convolution output based on the first input, and
a binding operator to generate the first embedding by performing circular convolution on the first input using a binding key.
